(19) United States
(12) Patent Application Publication
(10) Pub. No.: US 2005/0118944 A1
(43) Pub. Date: Jun. 2, 2005

(54) Heating, ventilating and/or air conditioning apparatus for a motor vehicle cabin, with temperature regulation by zone

(75) Inventors: Philippe Vincent, Epernon (FR); Philippe Pierres, Maurepas (FR)

Correspondence Address: Valeo Climate Control Corp.;Intellectual Property Dept., 4100 North Atlantic Boulevard, Auburn Hills, MI, 48326, US

(73) Assignee: Valeo Climatisation S.A., La Verriere (FR)

(21) Appl. No.: 10/990,171

(22) Filed: Nov. 16, 2004

(30) Foreign Application Priority Data
Nov. 28, 2003 (FR) 03 14035

(51) Int. Cl. B60H 3/00

(52) U.S. Cl. 454/121; 454/156

(57) ABSTRACT

The apparatus of this invention comprises a casing (10) having an upstream chamber (12) which feeds with cold air an auxiliary duct (40) that supplies at least one first duct (52, 54), which feeds a rear zone (ZAr) of the cabin; a first mixing chamber (20) which supplies processed air to second ducts (30, 32, 34) that feed a front zone (ZAv) of the cabin; and a heating chamber (16) which supplies heated air to the mixing chamber (20) and the first duct or ducts. The device further comprises a second mixing chamber (50) and a single distribution shutter valve (56), having a first control member (60) which is arranged to distribute part of the heated air coming from the heating chamber (16) selectively, either to the first mixing chamber (20) or to the second mixing chamber (50); and a second control member (62) arranged to control distribution of the mixed air from the second mixing chamber through the first duct or ducts (52, 54). Applicable to motor vehicles.

This invention relates to the field of heating, ventilating and/or air conditioning for motor vehicle cabins.

More particularly, it relates to apparatus for heating and ventilating and/or air conditioning for a motor vehicle cabin, which comprises a casing that includes an upstream chamber, which feeds fresh air to an auxiliary duct for supplying at least one first duct for feeding a rear zone of the cabin under the control of first air distribution means, a first mixing chamber for feeding processed air to second ducts for supplying a front zone of the cabin, and a heating chamber for supplying heated air to the mixing chamber and the first duct or ducts.

It is already known, especially from FR 2 795 683 and FR 2 795 684, to provide apparatuses of this type. They enable the atmospheric parameters in a motor vehicle cabin to be regulated in a front zone and a rear zone of the latter.

These known apparatuses work satisfactorily, but they do have the disadvantage that the air distribution means which control the rear zone of the cabin make it necessary to provide a number of valves with complex kinematics, which increases the complexity of the apparatus.

In addition, the said distribution means are bulky and in consequence they increase the size of the apparatus, so that the space available for items of motor vehicle equipment is more and more limited.

A main object of the invention is to overcome the above mentioned drawbacks.

In consequence, it proposes an apparatus of the type defined in the introduction hereof, which includes at least one second mixing chamber situated at the intersection of the auxiliary duct with the heating chamber and first duct, and a single distribution shutter valve having a first control member for selectively distributing a part of the heated air from the heating chamber either towards the first mixing chamber or towards the second mixing chamber, whereby to produce therein a stream of mixed air, together with a second control member adapted to control the distribution of the mixed air from the second mixing chamber through the first duct or ducts.

The apparatus of the invention thus includes a single distribution shutter valve, the function of which is essentially, firstly to distribute selectively a part of the heated air coming from the mixing chamber, and secondly to control the distribution of the mixed air taken from the second mixing chamber through the first duct or ducts, that is to say towards the rear zone of the cabin.

This results in simplification of the apparatus and reduction in the overall size of the latter.

In one preferred embodiment of the invention, the single distribution shutter valve includes an axis of rotation which carries the first control member and the second control member, and the first control member is arranged to cooperate with a first wall which is situated in the heating chamber and which delimits an air passage for the said part of the heated air, while the second control member is arranged to cooperate with a second wall which contributes to the delimitation of the second mixing chamber, and into which at least one air outlet, for feeding the first duct or ducts, exhausts.

In a first modified embodiment of the invention, which is of simplified design, the second wall includes a single air outlet which feeds a single first duct, the distribution shutter valve is displaceable between a first position, in which the first control member opens the air passage while the second control member closes off the air outlet, and a second position, for rear air distribution, in which the first control member closes off the air passage while the second control member opens the air outlet.

Complementary and/or alternative features of this first modified embodiment are as follows:
the first control member includes a generally rectangular vane, which extends from the axis of rotation and which is bounded by an edge adapted to cooperate with the first wall, while the second control member includes a shell element fixed to the axis of rotation and arranged for cooperation with the second wall, which is of cylindrical form;
the first wall ends in a terminal edge with which the edge of the first control member co-operates when the distribution shutter valve is in the rear distribution position.

In a second modified embodiment of the invention, which has a more developed design, the second wall includes at least two air outlets which are offset circumferentially with respect to the axis of rotation and which supply two first ducts, and the distribution shutter valve is displaceable between a first distribution position in which the first control member opens the air passage while a second control member closes off the two air outlets, and two rear distribution positions in which the first control member closes off the air passage while the second control member opens a respective one of the two air outlets.

Complementary and/or alternative features of this second variant are as follows:
the two air outlets comprise a rear foot zone outlet and a rear ventilating outlet, which feed, respectively, a rear foot zone duct and a rear ventilating duct, and the distribution shutter valve is displaceable between a first extreme position, which corresponds to the first distribution position, and a second extreme position which corresponds to a rear ventilating position in which the rear ventilating outlet is open, the distribution valve occupying at least one intermediate position which corresponds to a rear foot zone position in which the rear foot zone outlet is open;
the first control member includes a generally rectangular vane, which extends from the axis of rotation and which is bounded by an edge adapted to cooperate with the first wall, while the second control member includes a shell element fixed to the axis of rotation and arranged for cooperation with the second wall, which is of cylindrical form, together with a radial vane which is arranged to close off the rear foot zone outlet when the distribution valve is in its rear ventilating position; and
the first wall comprises a circular cylindrical portion with which the edge of the first control member co-operates when the distribution valve is in one or other of its rear distribution positions.

In a third modified embodiment, which corresponds to another developed design, the second wall includes at least two air outlets which are offset axially on a common generatrix which is parallel to the axis of rotation, and which feed two first ducts, and the distribution shutter valve is displaceable between a first position in which the first control member opens the air passage while a second control member closes off the two air outlets, and two rear distribution positions in which the first control member closes off the air passage while the second control member opens a respective one of the two air outlets.

Complementary and/or alternative features of this third variant are as follows:
the two air outlets comprise a rear foot zone outlet and a rear ventilating outlet, which feed, respectively, a rear foot zone duct and a rear ventilating duct, and the distribution shutter valve is displaceable between a first extreme position, which corresponds to the first distribution position, and a second extreme position which corresponds to a rear ventilating position in which the rear ventilating outlet is open, the distribution valve occupying at least one intermediate position which corresponds to a rear foot zone position in which the rear foot zone outlet is open;
the first control member includes a generally rectangular vane, which extends from the axis of rotation and which is bounded by an edge adapted to cooperate with the first wall, while the second control member includes a shell element fixed to the axis of rotation and arranged for cooperation with the second wall, which is of cylindrical form, the shell element including portions which are adapted to close or open the rear ventilating outlet and the rear foot zone outlet selectively, together with at least one radial vane which is adapted to close off the rear foot zone outlet when the distribution valve is in its rear ventilating position;
the first wall comprises a circular cylindrical portion with which the edge of the first control member co-operates when the distribution valve is in one or other of its rear distribution positions;
the apparatus has two rear foot zone outlets which flank a rear ventilating outlet;
the apparatus includes at least one rear foot zone outlet and at least one rear ventilating outlet, which are offset circumferentially and axially with respect to the axis of rotation.

The apparatus may include a central baffle, total or partial, which is located in the second mixing chamber whereby to define respective air streams for a right hand part and a left hand part of the cabin.

In particular, the central baffle may be total, whereby to divide the second mixing chamber into two chambers, each of which contains one distribution shutter valve for managing the distribution and temperature of the air streams in the right hand and left hand parts of the cabin.

In the following description, which is given by way of example only, reference is made to the attached drawings, in which:

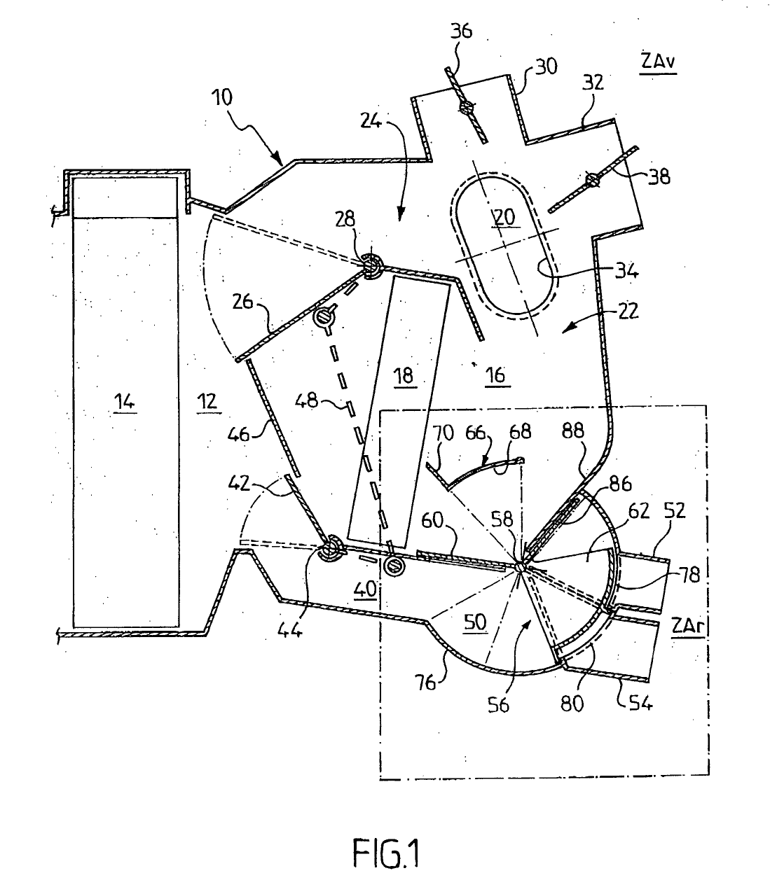

FIG. 1 shows diagrammatically, in a cross sectional view, an apparatus according to the invention in a first embodiment;

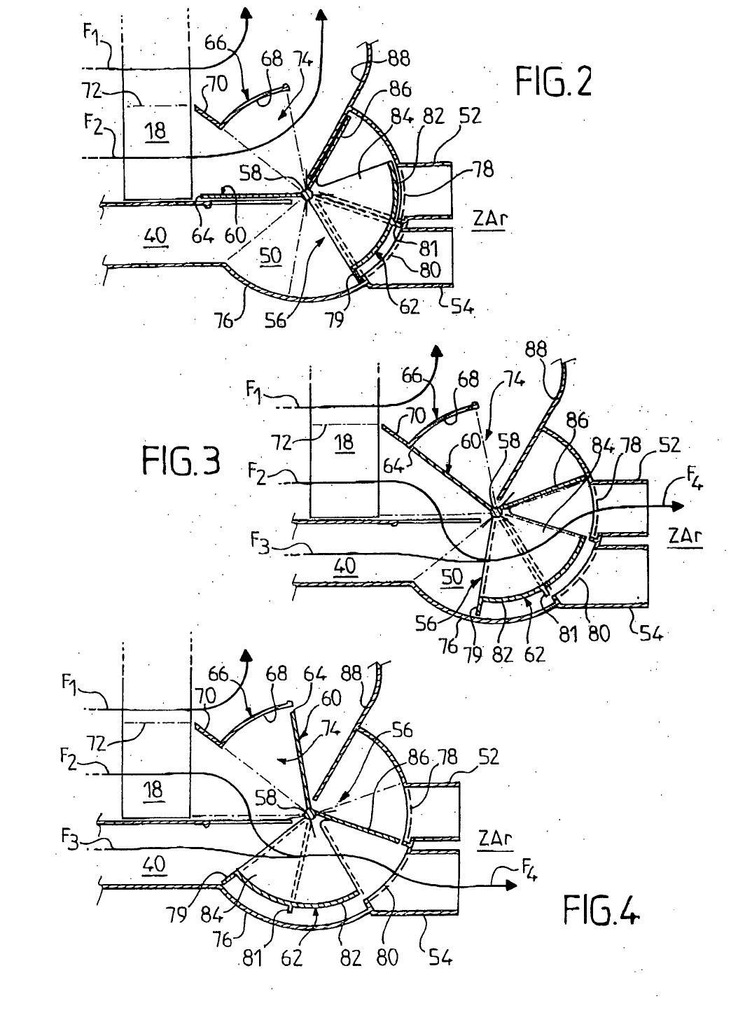

FIGS. 2 to 4 show part of the apparatus of FIG. 1, in which the single distribution shutter valve is shown in three different regulating positions which are, respectively, a “de-icing” position, a “foot zone” position and a “ventilating” position;

FIGS. 5 to 8 show, respectively, four possible configurations for the “foot zone” and “ventilating” outlets of a casing which contains the single distribution shutter valve;

FIG. 9 is a perspective view of the single distribution shutter valve in the apparatus of FIGS. 1 to 4;

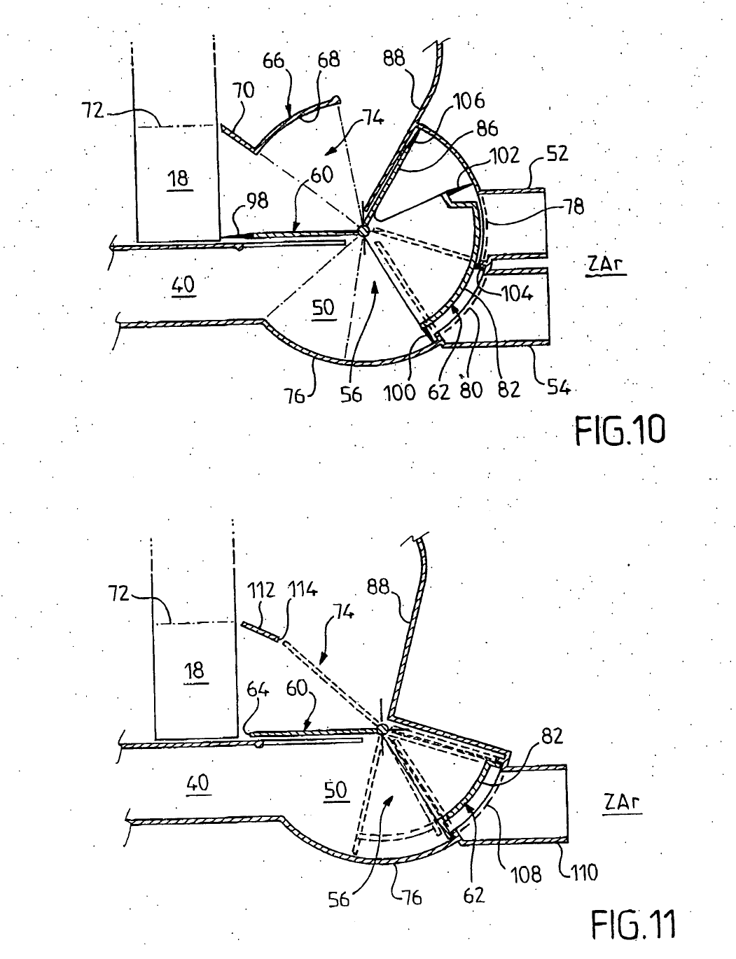

FIG. 10 is a detail of the apparatus of FIG. 1, showing the means for sealing the single distribution shutter valve;

FIG. 11 shows diagrammatically an apparatus according to a second embodiment of the invention which corresponds to a simplified design;

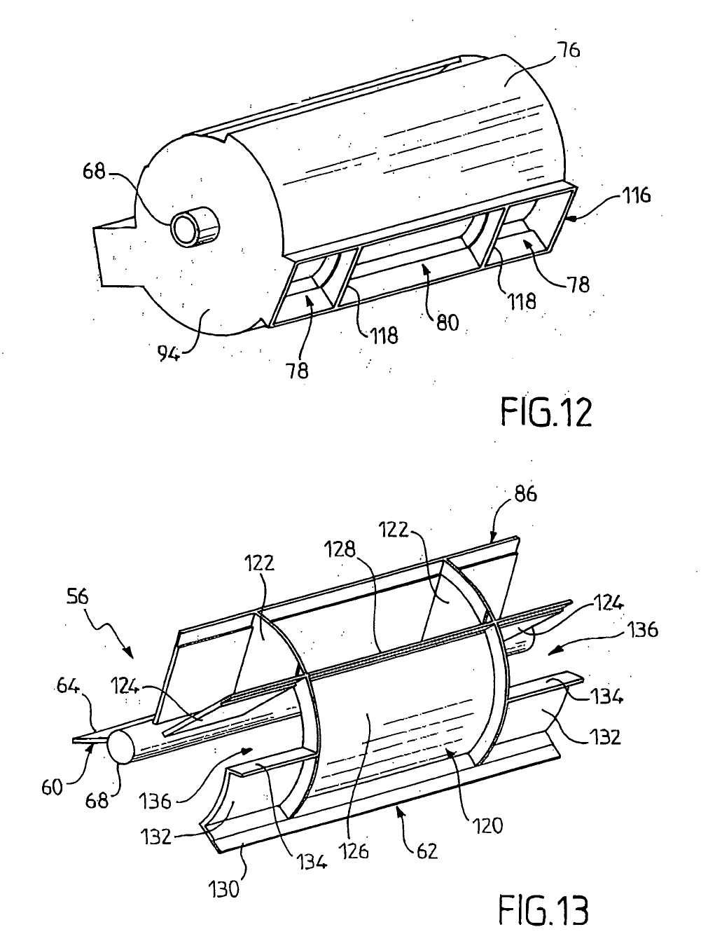

FIG. 12 shows, in perspective, a casing containing a single distribution shutter valve in a third embodiment of the invention;

FIG. 13 is a perspective view of the distribution shutter valve mounted in the casing of FIG. 12;

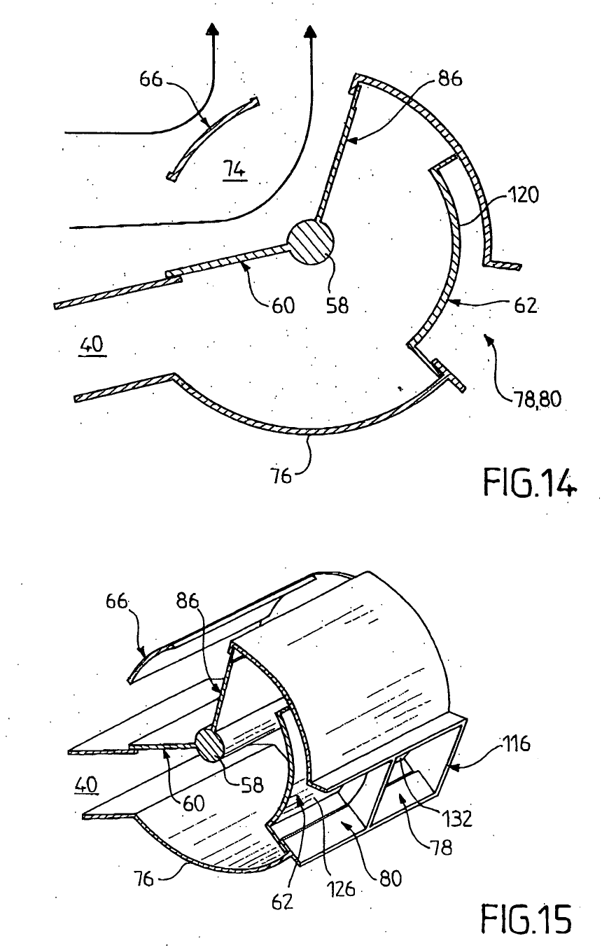

FIGS. 14 and 15 are a diagrammatic view and a perspective view of the casing and the valve of FIGS. 12 and 13, in a “de-icing” position;

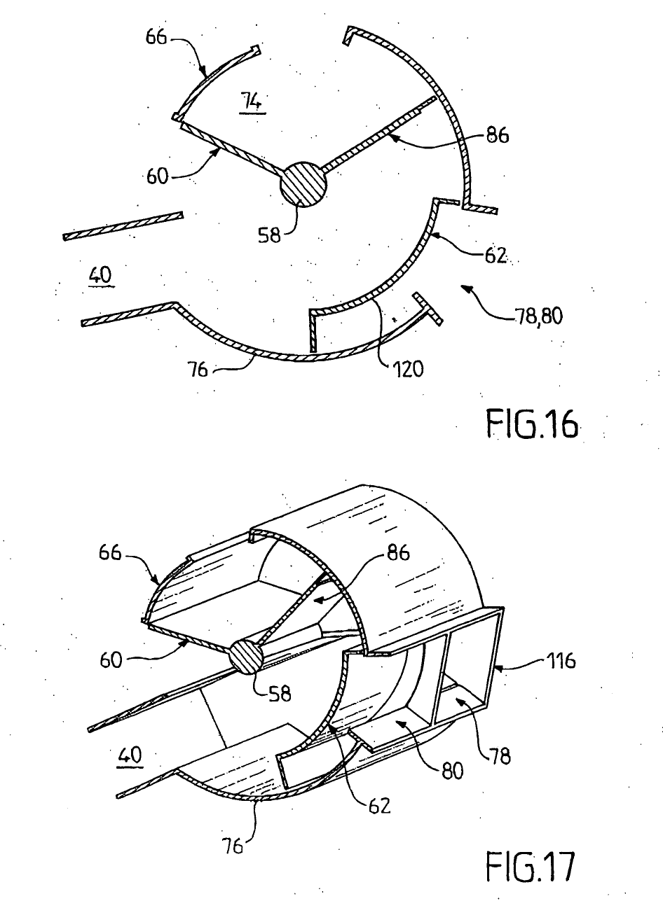

FIGS. 16 and 17 show diagrammatically and in cross section the casing and the distribution valve in a “foot zone” position, with the rear ventilating output closed;

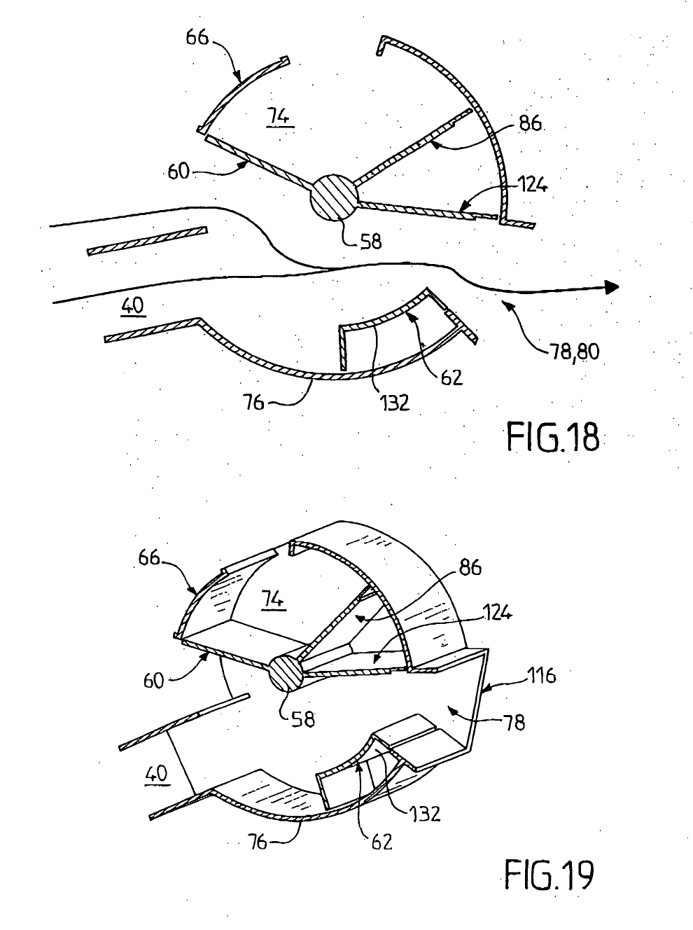

FIGS. 18 and 19 are, respectively, a diagrammatic view and a view in cross section in the “foot zone” position, showing the foot zone outlet open;

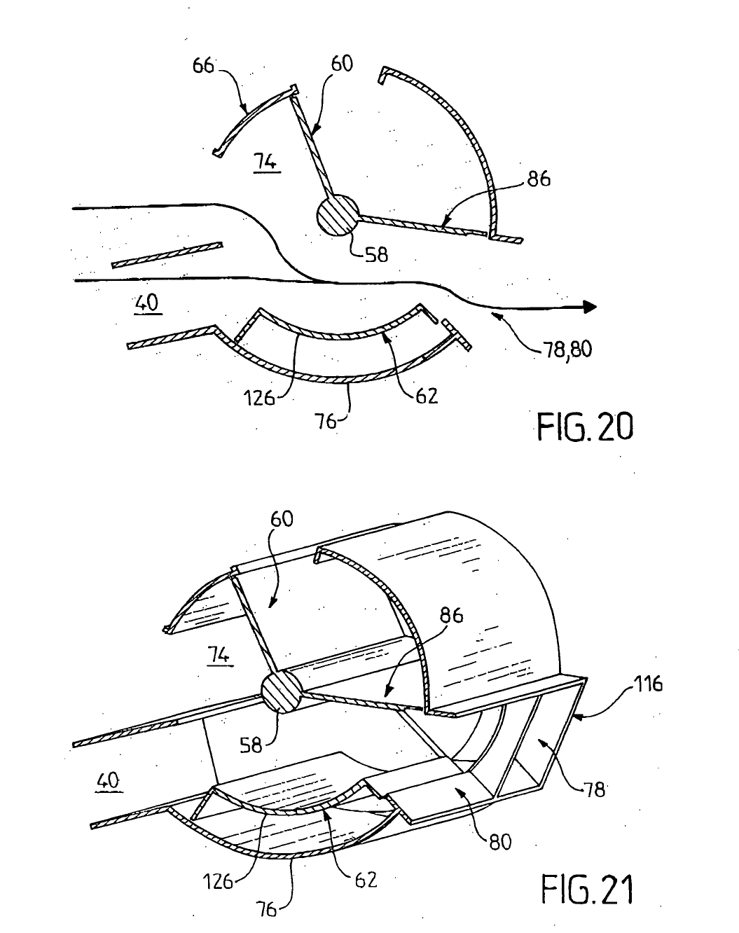

FIGS. 20 and 21 are views similar to FIGS. 16 and 17 in the “ventilating” position; and

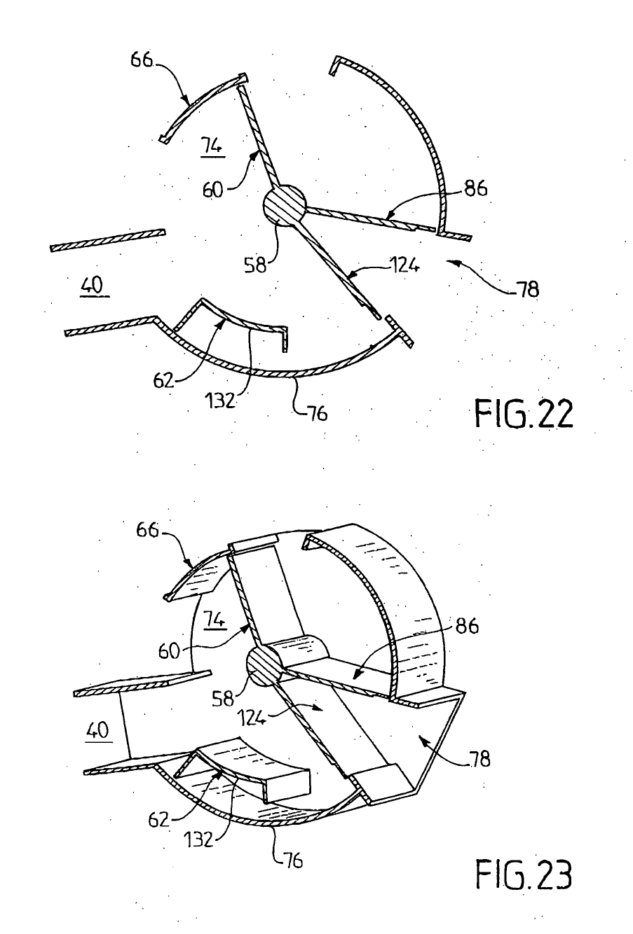

FIGS. 22 and 23 are views similar to FIGS. 18 and 19 in the “ventilating” position.

Reference is first made to FIG. 1, which shows a first embodiment of an apparatus according to the invention which is part of a heating and ventilating and/or air conditioning installation for a motor vehicle cabin, which has a front zone and a rear zone.

The apparatus comprises a casing 10 defining an upstream chamber 12 which contains, in this example, an evaporator 14 which is part of a conventional air conditioning circuit (not shown). The upstream chamber 12 is fed with fresh air (from outside and/or recirculated) which is propelled by a motorised fan unit (not shown).

The casing 12 also defines a heating chamber 16 which contains a heating radiator 18, through which there passes a hot fluid, usually the coolant liquid for the engine of the vehicle.

The casing 10 also defines, in its upper part, a first mixing chamber 20 which has an input 22 for reheated air that comes from the heating chamber 16, and an input 24 for the fresh air coming from the upstream chamber 12.

A first mixing valve 26, which in this example is of the “curtain” type, is mounted for pivoting movement about an axis 28. It distributes the proportion of cold air and hot air which is fed to the first mixing chamber 20 for the purpose of producing in the latter a stream of processed air at a regulated temperature. The valve 26 is displaceable between two extreme positions, namely an open position shown in full lines, in which the mixing chamber 20 is fed with fresh air, and a closed position shown in broken lines, in which the inlet of the mixing chamber is closed, so that the fresh air is passed towards the heating radiator 18. The valve 26 may adopt different intermediate positions for the distribution of fresh air between the inlet 24 of the mixing chamber 20 and the inlet of the heating radiator 18.

The said first mixing chamber 20 feeds processed air to ducts 30, 32 and 34 for supplying a front zone ZAv of the cabin. The duct 30 supplies at least one de-icing/demisting vent for the windscreen, under the control of a valve 36, while the duct 32 feeds at least one central ventilating outlet vent under the control of the valve 38. Finally, two ducts 34 are fitted laterally on either side of the casing 10, for supplying respective ventilating outlet vents (not shown) which are open at the two ends of the fascia panel. In consequence, the ducts 30, 32 and 34 enable the processed air to be passed into the front zone ZAv of the cabin.

The casing 10 delimits, in its lower part, an auxiliary duct 40 which is adapted to be supplied with fresh air through the upstream chamber 12 under the control of a second mixing valve 42, which in this example is of the “curtain” type and which is pivoted about an axis 44. The valve 42 is displaceable between two extreme positions, namely an open position shown in full lines, in which the auxiliary duct 40 is supplied with fresh air, and a fully closed position shown in broken lines, in which the inlet of the auxiliary duct 40 is closed. The valve 42 can also assume intermediate positions so as to adjust the proportion of fresh air to be distributed either towards the auxiliary duct 40 or towards the heating radiator 18 and therefore towards the heating chamber 16.

A baffle 46 is placed between the valves 26 and 42. These two latter are controlled by control devices 48 which are shown diagrammatically here.

The general structure of the apparatus, as described up to this point, is generally known, especially from the publications FR 2 795 683 and FR 2 795 684 which have already been mentioned.

In accordance with the invention, the casing 10 further delimits a second mixing chamber 50 which is located in the lower part and which is situated at the intersection of the auxiliary duct 40, the heating chamber 60, and two first ducts 52 and 54 which supply a rear zone ZAr of the cabin. The duct 52 is called the “rear foot zone” duct, while the duct 54 is called the “rear ventilation” duct.

A single distribution shutter valve 56, which is mounted rotatably about an axis 58, enables part of the hot air coming from the heating chamber 16 to be distributed selectively either towards the first mixing chamber 20 or towards the second mixing chamber 50, so as to produce a stream of mixed air. In addition, the valve 56 has the function of controlling the distribution of the mixed air that comes from the second mixing chamber 50 through the above mentioned ducts 52 and 54.

Reference is now made to FIGS. 2 to 4, so as to describe more particularly the structure of the distribution shutter valve 56 and its operation. The axis of rotation 58 of the valve supports a first control member 60 and a second control member 62. The first control member 60 comprises a vane of generally rectangular form, which extends from the axis of rotation 58 and which is bounded by an edge 64 parallel to the axis 58. This edge 64 is arranged to cooperate with a first wall 66 which has a circular cylindrical portion 68 that extends over a limited angle (about 45° in this example). This portion 68 is joined to a baffle portion 70 which opens in an outlet face of the heating radiator 18 and which enables an imaginary line 72, separating an upper hot air stream (arrow F1) and a lower hot air stream (arrow F2), to be delimited. The first wall 66 is situated in the heating chamber 16 so as to contribute to the delimitation therein of an air passage 74 for a part of the heated air (arrow F2).

The second control member 62 is arranged to cooperate with a second wall 76, which in this example is of circular cylindrical form and which partly delimits the second mixing chamber 50. Two air outlets, open in this second wall 76, consist of a “rear foot zone” outlet 78 and a “rear ventilation” outlet 80. The outlets 78 and 80 are offset angularly with respect to the axis of rotation 58, and they feed the ducts 52 and 54 respectively.

The second control member 62 comprises a shell element 82, of cylindrical form here, which is connected to the axis of rotation 58 through radial plate elements 84, as is best seen in the perspective view of FIG. 9. The term “shell element”, as used herein, is to be understood to mean a wall which is essentially non-radial with respect to the axis of rotation 58, and which may in particular have a flat, cylindrical, or crooked form, and of which the periphery is able to close or open at least one aperture for passage of air. The second control member 62 also includes a radial vane 86 which is situated between the vane 60 that constitutes the first control member and the shell element 82. A radial baffle 88, which is arranged in the heating chamber 16, extends from close to the axis 58 and serves as an abutment for the radial vane 86 in the de-icing position of FIG. 2.

The operation of the distribution shutter valve 56 will now be described in three modes which correspond to FIGS. 2 to 4. In the de-icing mode of FIG. 2, the distribution vale 56 is in a first extreme position in which the control member 60 leaves the air passage 74 open and closes off access to the mixing chamber 50. As a result, the two hot air streams F1 and F2 are diverted upwards and led to the first mixing chamber 20, which supplies the front zone of the cabin. This enables benefit to be obtained from the whole of the power from the heating radiator, at the de-icing vents which are supplied through the duct 30 (FIG. 1). In this position, the auxiliary duct 40 is closed by the mixing valve 42, and in addition, the second control member 62 closes off the outlets 78 and 80. In this connection, the shell element 82 extends over a sufficiently large angle (in this example substantially less than 90°) to close off, at the same time, the outlets 78 and 80 which are offset circumferentially. In this position, the radial vane 86 comes into engagement against the baffle 88.

In the “foot zone” distribution mode of FIG. 3, the distribution shutter valve has pivoted through an angular fraction (which in this example is of the order of 30°) about the axis 58, with respect to the position of FIG. 2, in the clockwise direction in the drawings. The edge 62 of the control member 60 comes into co-operation with one end of the cylindrical portion 68, which thereby closes off the air passage 74. This position corresponds to an intermediate position in which the shell element 82 of the control member 62 has opened the rear foot zone outlet 78, while maintaining the rear ventilation outlet closed. In consequence, a part of the hot air stream (arrow F2) can reach the mixing chamber 50 and become mixed in it with fresh air (arrow F3), under the control of a mixing valve 42. The stream of mixed air with adjustable temperature, which is obtained in this way, escapes through the rear foot zone outlet 78 and thus reaches the rear foot zone duct 52 as shown by the arrow F4.

In the “ventilating” distribution mode shown in FIG. 4, the valve has again pivoted clockwise from the previous position, and is in another extreme position. In this extreme position, the shell element 82 of the control member 62 has opened the ventilating outlet 80, while the rear foot zone outlet 78 is closed by the radial vane 86. As a result, the air passage 74 is still closed as in the previous position, and the hot air stream F2 mixes with the fresh air stream F3 to produce a stream of mixed air F4 which passes through the ventilating outlet 80 so as to supply the rear ventilating duct 54.

As can be seen in FIGS. 2 to 4, surfaces 79 and 81 are arranged between the valve 56 and the wall 76 of the casing, so as to guarantee sealing in at least one distribution mode. In this example, the two surfaces 79 and 81 extend parallel to the axis of rotation 58, and extend radially from the shell element 82. The peripheries of these surfaces are offset from each other in order to permit both sealing and rotational movement of the shutter valve. The surfaces 79 and 81 enable fully sealed closing of the outlets 78 and 80 to be achieved in the de-icing mode shown in FIG. 2. The sealing surfaces may be replaced by other sealing means, in particular by flexible lip seals.

In the embodiment shown in FIGS. 1 to 4, the outlets 78 and 80 are offset circumferentially with respect to the axis of rotation 58 on the wall 76. Different configurations for these two outlets are shown in FIGS. 5 to 8.

In the case of FIG. 5, the outlets 78 and 80 extend practically over the whole width of the casing 10, as it is defined between the side walls 94 of the casing. Also shown in FIG. 5 is the plane of symmetry S of the casing, which extends vertically and substantially halfway between the side walls 94.

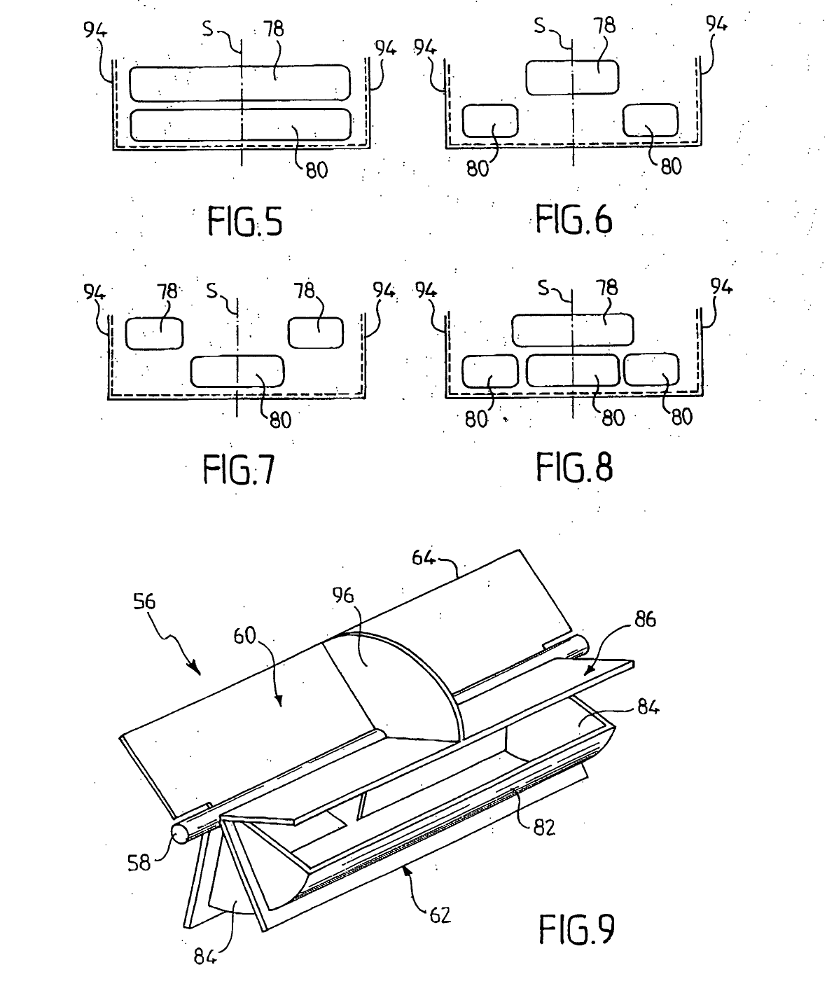

In the case of FIG. 6, the apparatus has a single foot zone outlet 78, which is situated in the centre, together with two rear ventilation outlets 80 which are symmetrical with respect to the plane of symmetry S and which are situated close to the respective end walls 94.

In the case of FIG. 7, the apparatus has two rear foot zone outlets 78 which are disposed symmetrically with respect to the plane of symmetry, together with a single rear ventilating outlet 80 which is situated in the centre. In the case of FIG. 8, the apparatus has one rear foot zone outlet 78 and three rear ventilating outlets 80, with one outlet 80 being in the centre and two outlets 80 situated at the sides.

As a result, the apparatus then includes at least one rear foot zone outlet 78 and at least one rear ventilating outlet 80, which are offset circumferentially and/or axially with respect to the axis of rotation.

FIG. 9 shows in perspective the structure of the shutter valve 56. The axis 58 will be noted, as will the first control member 60 which is made in the form of a vane of generally rectangular form, and the second control member 62, which comprises a shell element 82 mounted on two radial plate elements 84, and, in addition, the radial vane 86. As is shown in FIG. 9, it is possible to provide a central baffle 96 in the case of an apparatus in which distribution and temperature are managed separately for the left hand and right hand parts of the cabin. In this example, this central baffle is part of the shutter valve 56.

Thus, the extent of the central baffle may be partial as shown in FIG. 9, in order to direct the processed air streams into the right hand part and the left hand part of the cabin. It is also possible that the central baffle 96 extends over the whole of the transverse cross section of the wall 76, thereby enabling total separation to be achieved between the processed air streams in the right hand and left hand parts.

In this embodiment, it can be advantageous to arrange to have two shutter valves 56 of the type described above, which are arranged respectively on either side of the central baffle 96. In that case, the central baffle 96 is preferably fixed in the mixing chamber 50, so as to delimit two sub-chambers which are associated with the right hand and left hand parts of the cabin respectively. In another version, the central baffle may be integral with one or other of the two valves.

Reference is now made to FIG. 10, which once again shows the distribution shutter valve 56 in its de-icing position. It will be noted that this valve is provided with a number of seals, namely a lip seal 98 which constitutes the edge of the control member 60, and three lip seals 100, 102 and 104 with which the shell element 82 is equipped. The lip seals 100 and 102 are situated at the ends of the shell element, while the lip seal 104 is between the seals 100 and 102. Finally, the radial vane 86 is provided with a lip seal 106. The main function of the lips 100, 102 and 104 is to provide sealing on appropriate surfaces in the de-icing mode, in a similar way to the surfaces 79 and 81 in FIGS. 2 to 4. It may also wipe the internal walls of the casing and thereby guarantee perfect sealing in all the distribution modes. The preferred method of manufacturing this arrangement is to mould a flexible and elastic material in situ.

Reference is now made to FIG. 11, which shows a simplified version of the apparatus. In this example, the second wall 76 has a single air outlet 108 which feeds a single duct 110, and the latter, in its turn, feeds the rear zone ZAr. The distribution shutter valve 56 is displaceable between a de-icing position (shown in full lines in FIG. 11), in which the control member 60 opens the air passage 74, while the control member 62 closes off the single air outlet. The valve 56 may also occupy a rear distribution position (represented in broken lines), in which the control member 60 closes off the air passage 74 while the second control member 62 opens the air outlet 108. As in the preceding embodiment, the control member 60 includes a generally rectangular vane having an edge 64. However, in the present case the first wall is limited to a baffle 112 which terminates in a terminal edge 114 with which the edge 64 of the control member 60 co-operates when the distribution valve is in its rear distribution position.

In the embodiment shown in FIGS. 12 to 24, the second wall 76 and the casing (see FIG. 12) has three air outlets which are offset axially along a generatrix which is parallel to the axis of rotation 58, that is to say a rear ventilating outlet 80 which is flanked by two rear foot zone outlets 78, these three outlets being delimited by a rectangular frame 116 and two transverse baffles 118. The air outlets 78 delimit two respective ducts 52, while the air outlet 80 feeds a duct 54.

The distribution shutter valve 56 (see FIG. 13) comprises a first control member 60 which is made in the form of a rectangular vane terminated by an edge 64 which is arranged to cooperate with a wall 66 having a circular cylindrical portion 68, similar to that in the first embodiment.

The first control member 60 of the shutter valve includes a cylindrical shell element 120 which is arranged to cooperate with the above mentioned cylindrical wall 76. The second control member 62 thus comprises a radial vane 86 similar to that in the first embodiment. The shell element 120 is attached to the vane 86 by two spacer elements 122 of circular arcuate form, which are aligned with the two baffles 118.

The two spacer elements 122 serve as a support for two side baffles 124 which extend radially and which are attached to the spacer elements 122. The shell element 120 has a central portion 126 which extends between the two spacer elements 122 from an edge 128 parallel to the axis of rotation and lying between the side baffles 124, up to an edge portion 130 which extends over the whole axial length of the valve. The central portion1126 is flanked by two lateral portions 132. Each of these portions extends between an edge portion 134 which is spaced away from the end of the baffle 124, and the edge 130. As a result, two side apertures 136 are defined on either side of the spacer elements 122.

The operation of an apparatus in this third embodiment of the invention will now be described with reference to FIGS. 14 to 23.

In the “de-icing” position shown in FIGS. 14 and 15, the first control member 60 opens the air passage 74 while the second control member 62 closes off the two air outlets 78 and 80. More particularly, the central portion 126 of the shell element 120 closes off the central outlet 80, while the two side portions 132 close off the two respective side outlets 78.

In the “foot zone” position shown in FIGS. 16 to 19, the first control member 60 closes off the air passage 74, while the second control member 62 opens one of the two air outlets, namely the two foot zone outlets 78 which are situated at the sides. The central portion 126 of the shell element 120 closes off the rear ventilating outlet 80, while the two side portions 132 are offset and the apertures 136 are in register with the outlets 78 so as to leave them free.

In the “ventilating” position shown in FIGS. 20 to 23, which constitutes another rear distribution position, the first control member 60 is still closing off the air passage 74, while the second control member 62 opens the rear ventilating outlet 80. On the other hand, in this position, the two side baffles 124 close off access to the rear foot zone outlets 78.

The invention is of course capable of numerous modifications.

1. Apparatus for heating and ventilating and/or air conditioning a motor vehicle cabin, which comprises a casing (10) that includes an upstream chamber (12), which feeds fresh air to an auxiliary duct (40) for supplying at least one first duct (52, 54; 110) for feeding a rear zone (ZAr) of the cabin under the control of first air distribution means, a first mixing chamber (20) for feeding processed air to second ducts (30, 32, 34) for supplying a front zone (ZAv) of the cabin, and a heating chamber (16) for supplying heated air to the mixing chamber (20) and the first duct or ducts (52, 54; 110),
characterised in that it includes at least one second mixing chamber (50) situated at the intersection of the auxiliary duct (40) with the heating chamber (16) and first duct (52, 54; 110), and a single distribution shutter valve (56) having a first control member (60) for selectively distributing a part of the heated air from the heating chamber (16) either towards the first mixing chamber (20) or towards the second mixing chamber (50), whereby to produce therein a stream of mixed air, together with a second control member (62) adapted to control the distribution of the mixed air from the second mixing chamber (50) through the first duct or ducts (52, 54; 110).

2. Apparatus according to claim 1, characterised in that the single distribution shutter valve (56) includes an axis of rotation (58) which carries the first control member (60) and the second control member (62), and in that the first control member (60) is arranged to cooperate with a first wall (66; 112) which is situated in the heating chamber (16) and which delimits an air passage (74) for the said part of the heated air, while the second control member (62) is arranged to cooperate with a second wall (76) which delimits the second mixing chamber (50), and into which at least one air outlet (78, 80; 108), for feeding the first duct or ducts (52, 54; 110), exhausts.

3. Apparatus according to claim 2, characterised in that the second wall (76) includes a single air outlet (108) which feeds a single first duct (110), and in that the distribution shutter valve (56) is displaceable between a first position, in which the first control member (60) opens the air passage (74) while the second control member (62) closes off the air outlet (108), and a second position, for rear air distribution, in which the first control member (60) closes off the air passage (74) while the second control member (62) opens the air outlet (108).

4. Apparatus according to claim 3, characterised in that the first control member (60) includes a generally rectangular vane, which extends from the axis of rotation (58) and which is bounded by an edge (64) adapted to cooperate with the first wall (112), while the second control member (62) includes a shell element (82) fixed to the axis of rotation (58) and arranged for cooperation with the second wall (76), which is of cylindrical form.

5. Apparatus according to claim 4, characterised in that the first wall (112) ends in a terminal edge (114) with which the edge (64) of the first control member (60) co-operates when the distribution shutter valve is in the rear distribution position.

6. Apparatus according to claim 2, characterised in that the second wall (76) includes at least two air outlets (78, 80) which are offset circumferentially with respect to the axis of rotation (58) and which supply two first ducts (52, 54), and in that the distribution shutter valve (56) is displaceable between a first distribution position in which the first control member (60) opens the air passage (74) while a second control member (62) closes off the two air outlets (78, 80), and two rear distribution positions in which the first control member (60) closes off the air passage (74) while the second control member (62) opens a respective one of the two air outlets (78, 80).

7. Apparatus according to claim 6, characterised in that the two air outlets comprise a rear foot zone outlet (78) and a rear ventilating outlet (80), which feed, respectively, a rear foot zone duct (52) and a rear ventilating duct (54), and in that the distribution shutter valve (56) is displaceable between a first extreme position, which corresponds to the first distribution position, and a second extreme position which corresponds to a rear ventilating position in which the rear ventilating outlet (80) is open, the distribution valve occupying at least one intermediate position which corresponds to a rear foot zone position in which the rear foot zone outlet (78) is open.

8. Apparatus according to claim 7, characterised in that the first control member (60) includes a generally rectangular vane, which extends from the axis of rotation (58) and which is bounded by an edge (64) adapted to cooperate with the first wall (66), while the second control member (62) includes a shell element (82) fixed to the axis of rotation (58) and arranged for cooperation with the second wall (76), which is of cylindrical form, together with a radial vane (86) which is arranged to close off the rear foot zone outlet (78) when the distribution valve is in its rear ventilating position.

9. Apparatus according to claim 8, characterised in that the first wall (66) comprises a circular cylindrical portion (68) with which the edge (64) of the first control member (60) co-operates when the distribution valve (56) is in one or other of its rear distribution positions.

10. Apparatus according to claim 2, characterised in that the second wall (76) includes at least two air outlets (78, 80) which are offset axially on a common generatrix which is parallel to the axis of rotation (58), and which feed two first ducts (52, 54), and in that the distribution shutter valve (56) is displaceable between a first position in which the first control member (60) opens the air passage (74) while a second control member (62) closes off the two air outlets (78, 80), and two rear distribution positions in which the first control member (60) closes off the air passage (74) while the second control member (62) opens a respective one of the two air outlets (78, 80).

11. Apparatus according to claim 10, characterised in that the two air outlets comprise a rear foot zone outlet (78) and a rear ventilating outlet (80), which feed, respectively, a rear foot zone duct (52) and a rear ventilating duct (54), and in that the distribution shutter valve (56) is displaceable between a first extreme position, which corresponds to the first distribution position, and a second extreme position which corresponds to a rear ventilating position in which the rear ventilating outlet (80) is open, the distribution valve occupying at least one intermediate position which corresponds to a rear foot zone position in which the rear foot zone outlet (78) is open.

12. Apparatus according to claim 11, characterised in that the first control member (60) includes a generally rectangular vane, which extends from the axis of rotation (58) and which is bounded by an edge (64) adapted to cooperate with the first wall (112), while the second control member (62) includes a shell element (82) fixed to the axis of rotation (58) and arranged for cooperation with the second wall (76), which is of cylindrical form, the shell element including portions (126, 132) which are adapted to close or open the rear ventilating outlet (80) and the rear foot zone outlet (78) selectively, together with at least one radial vane (86, 124) which is adapted to close off the rear foot zone outlet (78) when the distribution valve is in its rear ventilating position.

13. Apparatus according to claim 12, characterised in that the first wall (66) comprises a circular cylindrical portion (68) with which the edge (64) of the first control member (60) co-operates when the distribution valve (56) is in one or other of its rear distribution positions.

14. Apparatus according to one of claims 11 to 13, characterised in that it has two rear foot zone outlets (78) which flank a rear ventilating outlet (80).

15. Apparatus according to one of claims 11 to 13, characterised in that it includes at least one rear foot zone outlet (78) and at least one rear ventilating outlet (80), which are offset circumferentially and axially with respect to the axis of rotation (58).

16. Apparatus according to one of claims 1 to 15, characterised in that it includes a central baffle (96), total or partial, which is located in the second mixing chamber (50) whereby to define respective air streams for a right hand part and a left hand part of the cabin.

17. Apparatus according to claim 16, characterised in that the central baffle (96) is total, whereby to divide the second mixing chamber (50) into two chambers, each of which contains one distribution shutter valve (56) for managing the distribution and temperature of the air streams in the right hand and left hand parts of the cabin.
